(19) United States
(12) Patent Application Publication
(10) Pub. No.: US 2025/0305637 A1
(43) Pub. Date: Oct. 2, 2025

(54) HYDROGEN STORAGE DEVICE

(71) Applicant: GKN Hydrogen GmbH, Bonn (DE)

(72) Inventors: René LINDENAU, Radevormwald (DE); Bettina NEUMANN, Radevormwald (DE); Lars WIMBERT, Schwelm (DE)

(21) Appl. No.: 18/864,337

(22) PCT Filed: May 11, 2023
(86) PCT No.: PCT/EP2023/062607

§ 371 Date: Nov. 8, 2024

(30) Foreign Application Priority Data
May 11, 2022 (DE) 10 2022 111 770.7

(51) Int. Cl. F17C 11/00

(52) U.S. Cl. CPC F17C 11/005; F17C 2221/012

(57) ABSTRACT

The invention relates to a hydrogen storage device (1), at least comprising a container (2) having a volume (3) and having a wall (4) surrounding the volume (3) and, arranged in the container (2), at least one body (6) which consists of a material mixture (5) and which comprises at least a first material (7) capable of storing hydrogen and a second material (8) as a binder for the first material (7); wherein the first material (7) is distributed in a matrix of the second material (8).

### CROSS-REFERENCE TO RELATED APPLICATIONS

The present application is related and has right of priority to German Patent Application No. DE 102022111770.7 filed on May 11, 2022 and is a U.S. national phase of PCT/EP2023/062607 filed in the European Patent Office on May 11, 2023, both of which are incorporated by reference in their entireties for all purposes.

### TECHNICAL FIELD

The invention relates to a hydrogen storage device.

### BACKGROUND

A hydrogen storage element for a hydrogen storage device is known from WO 2015/169740 A1. The hydrogen storage element is produced by pressing and comprises a hydrogen-storing material and a heat-conducting material. Such hydrogen storage elements are stacked or arranged in a geometrically fixed manner with respect to one another and thus produce a hydrogen storage device. The individual layers of the hydrogen storage elements are aligned with respect to one another and functionally connected to one another, for example for heat conduction, for the passage of hydrogen, etc.

In order to enable the most effective possible utilization of space of hydrogen storage elements which are arranged in containers, the shape of the hydrogen storage elements should ideally correspond to the shape of the container.

As a result of the taking up of hydrogen, the density of the hydrogen-storing constituent of a hydrogen storage element decreases. The volume of the hydrogen storage element increases correspondingly. A particle refinement is associated with the repeated change in volume. In this case, in particular the hydrogen-storing constituents of the hydrogen storage element lose their original position in the hydrogen storage device and possibly collect at the bottom of the hydrogen storage device. This accumulation may lead to an inadmissibly large change in volume occurring in a region of a hydrogen storage device, with the result that a container surrounding the hydrogen storage elements may be damaged.

This damage to the container may also already occur during the change in volume of still intact water storage elements. For this reason, spacings are in particular provided between the hydrogen storage elements and the walls of the container, such that an expansion of the hydrogen storage elements is made possible. However, these spacings reduce a heat-conducting contact of the hydrogen storage elements with the wall, such that a control of the hydrogen output is difficult.

### SUMMARY

On the above basis, it is an object of the present invention to at least partially solve the problems described with reference to the prior art. In particular, a hydrogen storage device is to be proposed in which damage to the container may as far as possible not occur. In order to achieve this object, a hydrogen storage device according to the features of claim 1 is proposed. Advantageous developments are the subject matter of the dependent claims. The features listed individually in the claims may be combined with one another in a technologically meaningful manner and may be supplemented by explanatory facts from the description and details from the figures, wherein further embodiment variants of the invention are indicated.

A hydrogen storage device which comprises at least one container having a volume and having a wall surrounding the volume and, arranged in the container, at least one body consisting of a material mixture contributes to this. The body comprises (before the activation or storage of hydrogen) at least or exclusively a first material capable of storing hydrogen and a second material as binder for the first material, which is present in powder form, in particular before production of the body by pressing. The first material is arranged in a matrix of the second material in a distributed manner. The material mixture exhibits a high first density and a second density in a first state, in which a minimum amount of hydrogen is embedded in the first material, and exhibits a low second density and a second volume in a second state, in which a maximum amount of hydrogen is embedded in the first material. A factor of a density reduction, calculated according to the specification: F=1−second density/first density, is at least 0.13.

In particular, the body is produced by pressing and is therefore also referred to as a pressed body. A pressed body is an element produced by pressing. For this purpose, a first material in powder form, here together with the second material, which is, in particular, also provided in powder form is filled into a press mold and pressed into a pressed body by movable punches under a pressure of at least 50 MPa [MegaPascal], in particular of at least 100 MPa.

The first material is arranged, in particular, in a distributed manner in the second material. In particular, agglomerations of the first material should not be present here. In particular, the aim is to achieve a distribution of the first material in the second material which is as uniform as possible.

The second material is used, in particular, for fixing the first material. The second material thus forms, in particular, a matrix in which the first material is arranged in a distributed manner which is as uniform as possible. In particular, no compensation for the change in volume of the first material takes place. Rather, the second material or the matrix formed by the second material is deformable such that the change in volume of the first material brings about a corresponding change in the volume of the body, wherein, however, the uniform distribution of the first material in the second material is maintained.

Preferably, a warm pressing takes place, at which temperatures of at least 50 degrees Celsius, in particular of at least 70 degrees Celsius, preferably of at least 100 degrees Celsius, are produced in the pressed body. In particular, during the warm pressing
a temperature is set which substantially corresponds to the melting temperature of the second material used or deviates therefrom by at most 20 Kelvin. As a result of the increased temperature, the second material may be at least partially melted, such that a better connection of first material and second material takes place.

The proportion of the second material is, in particular, between 1 and 10% by weight. The proportion of the first material is, in particular, at least 85% by weight or, depending on the proportion of the second material, the remainder.

The factor of the density reduction is calculated according to the following formula: factor=1−second density/first density and is thus always between zero and one.

In particular, the factor is more than 0.15, preferably more than 0.2, particularly preferably more than 0.3 or even more than 0.4.

In particular, the first density is present after pressing the body. The first density is, in particular, in a range of 70% to 85% of the theoretical density of the material mixture used.

In particular, the first density is at most 87% of the theoretical density of the material mixture used.

Unless other details are given here, the properties of the materials or of the body are to be determined at customary room temperatures and atmospheric pressure.

The second density, that is to say the density of the material mixture which is present in the second state and in which a maximum amount of hydrogen is embedded in the first material, is, in particular, between 2.5 and 4.3 grams/cubic centimeter, preferably between 2.7 and 4.2 grams/cubic centimeter.

The second density, that is to say the density of the material mixture which is present in the second state, in which a maximum amount of hydrogen is embedded in the first material, is, in particular, between 43% and 76%, preferably between 47% and 74%, of the theoretical density of the material mixture used.

In particular, the second material enables the body, starting from the first state and towards the second state, to adapt to a shape of the shape-stable container. Spatial constraints present in one direction, for example by the wall of the container, are thereby circumventable by expansion of the body in a freely determinable other direction.

In particular, the body comprises a first expansion in a first direction and a second expansion in a second direction transverse to the first direction. The first expansion is limited in the first direction by the wall. The first direction thus runs, starting from a center of mass of the body, in particular perpendicularly to the wall. The second direction runs in particular transverse to the first direction, thus for example parallel to the first wall. In a cylindrical housing and a cylindrical body, the first direction is thus a radial direction and the second direction runs along the respective cylinder axis. At least 50%, preferably at least 75%, of a difference of first volume and second volume is realized by a variation of the second expansion.

In particular, the body expands more strongly in the second direction, in which a volume growth of the body is not limited by the wall, than in the first direction, in which the body abuts the wall during volume growth. In particular, the variation of the expansion in the second direction is at least 10%, preferably at least 20%, particularly preferably at least 30% greater than a variation of the expansion in the first direction.

In particular, the material mixture of the body enables the body, depending on a pressure acting on the body from outside, to expand in other directions. The body may thus, for example in a first state, contact the wall of the container and expand towards the second state almost exclusively in the second direction. A contact of the body by the wall of the container may thus be realized in particular in both states and in the intermediate states lying therebetween.

In particular, the container may be designed such that it exhibits a stiffness or strength generating this pressure. A yielding deformation of the wall does not have to be enabled.

In particular, the body is repeatedly deformable and the arrangement and distribution of the first material in the second material is maintainable or is maintained in the process. In particular, the second material enables an expansion and contraction of the first material (as a result of the taking up or release of hydrogen) without the matrix of the second material dissolving. The first material thus remains bound in the matrix of the second material and is arranged again in the respective position after a change of state. In particular, a separation of the second material and the first material and in particular a segregation of the fine powder formed from the first material does not occur.

In particular, at least one polymer is used as the second material.

In the present case, a preferred material mixture with the described properties is proposed, which may be used for producing a body. The material mixture enables the taking up of a high amount of hydrogen, wherein at the same time a permanent connection of the first material and the second material is realized. In this case, the second material enables a deformability of the body between the two (extreme) states.

Through the use of at least one polymer, certain optical, mechanical, thermal and/or chemical properties may be assigned to the pressed body or to the body. For example, the pressed body may, through the polymer, exhibit a good temperature resistance, a resistance to the surrounding medium (oxidation resistance, corrosion resistance), a good thermal conductivity, a good hydrogen take-up and storage capacity or other properties, such as, a mechanical strength, which would otherwise not be possible without the polymer. Polymers may also be used which, for example, enable no storage of hydrogen but enable a high expansion, such as, for example, polyamide or polyvinyl acetates.

In particular, the polymer may be a homopolymer or a copolymer. Copolymers are polymers which are composed of two or more different types of monomer units.

Preferably, the polymer (homopolymer) comprises a monomer unit which, in addition to carbon and hydrogen, preferably also has at least one heteroatom, selected from sulfur, oxygen, nitrogen and phosphorus, so that the polymer obtained, in contrast to polyethylene, for example, is not completely nonpolar. Also, at least one halogen atom, selected from chlorine, bromine, fluorine, iodine, may be present. Preferably, the polymer is a copolymer in which, in addition to carbon and hydrogen, at least one monomer unit also comprises at least one heteroatom, selected from sulfur, oxygen, nitrogen and phosphorus, and/or at least one halogen atom, selected from chlorine, bromine, fluorine, iodine, is present. Here, it is possible that two or more monomer units also comprise a corresponding heteroatom and/or halogen atom.

The polymer preferably has adhesive properties with regard to the first material. This means that it adheres well to the first material itself and thus forms a matrix which adheres stably to the first material even under stresses such as those occur during hydrogen storage.

The adhesive properties of the polymer enable a high stability of the pressed body over a period of time which is as long as possible, that is to say over a plurality of cycles of hydrogen storage and hydrogen output. Here, one cycle describes the process of a single hydrogenation and subsequent dehydrogenation. Here, the pressed body should preferably be stable over at least 500 cycles, in particular over at least 1000 cycles, in order to be able to use the material economically. Stable within the meaning of the present invention means that the amount of hydrogen which may be stored and the speed at which the hydrogen is stored substantially correspond to the values at the start of use of the pressed body even after 500 or even after multiple 1000 of cycles. In particular, stable means that the first material is held at least approximately at the position within the pressed body at which it was originally arranged.

In particular, stable is also to be understood as meaning that no demixing effects occur during the cycles in which relatively fine particles separate from relatively coarse particles (for example from the pressed body) and get removed.

The first material is, in particular, a low-temperature hydrogen storage material (low-temperature hydride). During hydrogen storage, which is an exothermic process, temperatures of up to 150° C. [degrees Celsius] occur. A polymer which is used here as the second material must be stable at these temperatures. A preferred polymer therefore does not decompose up to a temperature of 180° C., in particular up to a temperature of 165° C., in particular of up to 150° C.

In particular, the polymer is selected from EVA, PMMA, EEAMA and mixtures of these polymers.

EVA (ethyl vinyl acetate) refers to a group of copolymers of ethylene and vinyl acetate which comprise a proportion of vinyl acetate in the range of 2% by weight to 50% by weight. Lower proportions of vinyl acetate led to the formation of hard films, while higher proportions led to a greater adhesiveness of the polymer. Typical EVA are solid at room temperature and have an elongation at break of up to 750%. In addition, EVA are resistant to stress cracking.

Polymethyl methacrylate (PMMA) is a synthetic, transparent thermoplastic. The glass transition temperature lies, depending on the molar mass, at about 45° C. to 130° C. The softening temperature is preferably 80° C. to 120° C., in particular 90° C. to 110° C. The thermoplastic copolymer is distinguished by its resistance to weathering, light and UV radiation.

EEAMA is a terpolymer (copolymer) of ethylene, acrylate and maleic anhydride monomer units. EEAMA has a melting point of about 102° C., depending on the molar mass.

Preferably, the pressed body comprises exclusively the first material and the second material, that is to say the first material capable of storing hydrogen and the binder (possibly only with unavoidable impurities to the usual extent). The proportion by weight of the second material based on the total weight of the pressed body is preferably at most 10% by weight, in particular at most 5% by weight, preferably at most 1% by weight. The proportion by weight of the binder in the pressed body should be as low as possible. Even if the binder is possibly capable of also storing hydrogen, the hydrogen storage capacity is nevertheless not as pronounced as that of the first material (in particular, the hydrogen storage capacity of the second material is at most 20% of the hydrogen storage capacity of the first material). However, the binder may, on the one hand, reduce or completely avoid any oxidation of the first material which may occur and, on the other hand, ensures cohesion between the particles in powder form of the first material in the pressed body.

The first material may comprise, preferably consist of, at least one hydrogenatable metal and/or at least one hydrogenatable metal alloy. In addition, the following materials may be used as the hydrogenatable first material: alkaline earth metal and alkali metal alanates, alkaline earth metal and alkali metal borohydrides, metal organic frameworks (MOF's)/metal organic frameworks, and/or clathrates, and of course respective combinations of the respective materials. The first material may also comprise nonhydrogenatable metals or metal alloys.

According to the invention, the first material may comprise a low-temperature hydride, medium-temperature hydride and/or a high-temperature hydride. The term hydride here refers to the hydrogenatable material, irrespective of whether it is present in the hydrogenated form or the nonhydrogenated form. Low-temperature hydrides store hydrogen preferably in a temperature range between −55° C. and 180° C., in particular between −20° C. and 150° C., particularly between 0° C. and 140° C. High-temperature hydrides store hydrogen preferably in a temperature range from 280° C. and above, in particular from 300° C. and above. Medium-temperature hydrides store hydrogen preferably in the temperature range lying therebetween. At the temperatures mentioned, the hydrides may not only store hydrogen, but also release hydrogen, i.e. are functional in these temperature ranges.

If ‘hydrides’ are described in this context, this is to be understood as meaning both the hydrogenatable material in its hydrogenated form and in its nonhydrogenated form. In particular, hydrogenatable materials in their hydrogenated or nonhydrogenated form may be used in the production of hydrogen storage devices.

Hydrogen storage (hydrogenation) may take place at room temperature. The hydrogenation is an exothermic reaction. The resulting reaction heat may be dissipated. In contrast to this, energy in the form of heat is usually supplied to the hydride for the dehydrogenation. The dehydrogenation is an endothermic reaction.

In a hydrogenated second state, the pressed body has a lower second density and a greater second volume than in a dehydrogenated first state.

The first material is present, in particular, in powder form (that is to say as particles, particles) before the production of the pressed body.

The particles of the first material have, in particular, a particle size ×50 of 20 μm [micrometers] to 700 μm, in particular of 50 μm to 300 μm. Here, ×50 means that 50% of the particles comprise an average particle size which is equal to or less than the value mentioned. In the present case, the average particle size is the weight-based particle size. The particle size (particle size) of the hydrogenatable first material is indicated here before it is subjected to hydrogenation for the first time. During hydrogen storage, stresses occur in the material, which may lead to a reduction in the ×50 particle size taking place during a plurality of cycles.

During the reduction in the particle size, the particles do not disintegrate, in particular, because the individual segments of the particles are fixed/held together in their position by the binder. That is to say, the outer shape of the original particle is, in particular, maintained. After grain refining, however, these consist of a plurality of relatively small segments. In particular, through the second material, a fixing of the particles in the pressed body takes place.

In particular, a plurality of the bodies each having the same geometry are arranged in the container such that the mutually corresponding side surfaces of the bodies each extend parallel to one another. For example, the bodies may be constructed cylindrically. The bodies may be arranged stacked one on top of the other.

The end faces of the cylindrical bodies may be plane. A cylindrical circumferential surface of the bodies may extend in particular parallel to a wall of the container. The end faces extend in particular perpendicularly to the circumferential surface.

In particular, the body comprises at least one channel extending through the body. The channel may be provided, for example, for the passage of a temperature control fluid. The body may be heated and/or cooled by the temperature control fluid. The channel may be constructed in a straight manner. The container may comprise, for example, a conduit which extends through the channel. The body contacts the conduit in particular via the channel.

In particular, a plurality of the bodies are arranged in the container such that the channels are arranged in alignment with one another.

In particular, the second material has a hydrogen permeability and forms a seal of the first material with respect to at least one or more of N₂ (nitrogen), C (carbon), O (oxygen), CO₂ carbon dioxide), CO (carbon monoxide), H₂O (water), H₂S and hydrocarbon compounds such as CH₄, for example.

In particular, at least the second material has a melting temperature which differs by at most 20 Kelvin, in particular by at most 10 Kelvin, from a highest operating temperature of the hydrogen storage device. Thus, if operating temperatures of at most 50 degrees Celsius are reached, a second material is preferably selected which has a melting temperature of at most 70 degrees Celsius.

The melting temperature of the second material may also be lower than the highest operating temperature.

Depending on the application and the first material used, the operating temperature may, in particular, be between −10 and 140 degrees Celsius, in particular between zero and 80 degrees Celsius. When high-temperature hydrides are used, significantly higher operating temperatures may also be provided.

Such a selection of the second material enables softening of the second material during each cycle of hydrogenation and/or dehydrogenation. This softening enables a respective new formation of the cohesive connection between the first material and the second material both within the pressed body and, in particular, also between the pressed bodies.

In particular, the effect of the further segregation of the particles of the first material may thus also be counteracted or compensated for. Usually, the separated, smaller particles of the first material would detach from a pressed body and migrate downward with the force of gravity within the container and collect there. The volume expansion of the first material which then occurs there could cause local stresses in the container and thus at least lead to damage to the container.

In particular, the second material has a melting temperature which is higher than the highest operating temperature.

In particular, a material mixture is also proposed which may be used for the described body. The material mixture comprises (before the activation or storage of hydrogen) at least or exclusively a first material capable of storing hydrogen and a second material as binder for the first material, which is present in powder form before production of the body by pressing. The first material is arranged in a distributed manner in a matrix of the second material. The material mixture exhibits a high first density and a first volume in a first state in which a minimum amount of hydrogen is embedded in the first material and exhibits a low second density and a second volume in a second state in which a maximum amount of hydrogen is embedded in the first material. A factor of a density reduction, that is to say 1−second density/first density, is at least 0.13.

A body is proposed which is produced by pressing the described material mixture.

The explanations relating to the hydrogen storage device apply equally to the material mixture and the body and vice versa.

The use of indefinite articles (“a”, “an” and “an”), in particular in the claims and the description reproducing these, is to be understood as such and not as a numerical word. Terms or components introduced correspondingly therewith are thus to be understood as meaning that they are present at least once and, in particular, may also be present multiple times.

As a precaution, it should be noted that the numerical words used here (“first”, “second”, . . . ) serve primarily (only) to distinguish between a plurality of identical objects or sizes, that is to say in particular do not necessarily specify a dependence and/or order of these objects or sizes with respect to one another. Should a dependence and/or order be necessary, this is explicitly indicated here or is evident to a person skilled in the art when studying the specifically described configuration.

### BRIEF DESCRIPTION OF THE DRAWINGS

The invention and the technical environment are explained in more detail below with reference to the figures. It should be pointed out that the invention is not intended to be restricted by the exemplary embodiments shown. In particular, unless explicitly stated otherwise, it is also possible to extract partial aspects of the matters explained in the figures and to combine them with other parts and knowledge from the present description and/or figures. In particular, it should be pointed out that the figures and in particular the size ratios shown are only schematic. The same reference signs denote the same subject matter, so that explanations from other figures may optionally be used in addition. The figures show:

FIG. 1: a known hydrogen storage device in a first state in a side view in section;

FIG. 2: the hydrogen storage device according to FIG. 1 in a second state in a side view in section;

FIG. 3: a hydrogen storage device in a first state in a side view in section; and

FIG. 4: the hydrogen storage device according to FIG. 3 in a second state in a side view in section.

### DETAILED DESCRIPTION

Reference will now be made to embodiments of the invention, one or more examples of which are shown in the drawings. Each embodiment is provided by way of explanation of the invention, and not as a limitation of the invention. For example, features illustrated or described as part of one embodiment can be combined with another embodiment to yield still another embodiment. It is intended that the present invention include these and other modifications and variations to the embodiments described herein.

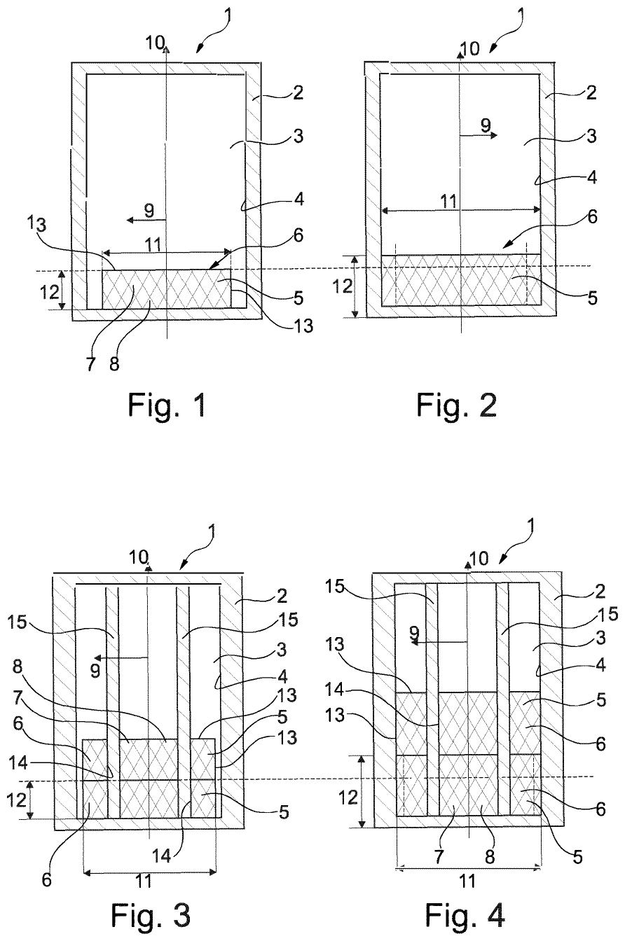

FIG. 1 shows a known hydrogen storage device 1 in a first state in a side view in section. FIG. 2 shows the hydrogen storage device 1 according to FIG. 1 in a second state in a side view in section. FIGS. 1 and 2 will be described together in the following.

The hydrogen storage device 1 comprises a container 2 having a volume 3 and having a wall 4 surrounding the volume 3 and, arranged in the container 2, a body 6. The body 6 exhibits a high first density and a small first volume in a first state (see FIG. 1), in which a minimum amount of hydrogen is embedded in the body 6, and exhibits a low second density and a second volume in a second state (see FIG. 2), in which a maximum amount of hydrogen is embedded in the body 6.

As a result of the take up of hydrogen, the density of the hydrogen-storing constituent of a hydrogen storage element decreases. The volume of the hydrogen storage element increases correspondingly. This repeated change in volume leads to the material 7, 8 of the body 6 increasingly disintegrating, that is to say a particle refinement is occurring. In this case, in particular the hydrogen-storing constituents of the hydrogen storage element lose their original position in the body 6 or in the hydrogen storage device 1 and possibly collect at the bottom of the hydrogen storage device 1. This accumulation may lead to an inadmissibly large change in volume occurring in a region of a hydrogen storage device 1, with the result that the container 2 surrounding the bodies 6 may be damaged.

This damage to the container 2 may also already occur during the change in volume of still intact bodies 6. For this reason, spacings (see FIG. 1) are provided between the body 6 and the walls 4 of the container 2, such that an expansion of the bodies 6 is made possible starting from the first state and towards the second state. However, these spacings reduce a heat-conducting contact of the bodies 6 with the wall 4, such that a control of the hydrogen output is difficult.

FIG. 3 shows a hydrogen storage device 1 in a first state in a side view in section. FIG. 4 shows the hydrogen storage device 1 according to FIG. 3 in a second state in a side view in section. FIGS. 3 and 4 will be described together in the following. Reference is made to the explanations relating to FIGS. 1 and 2.

The hydrogen storage device 1 comprises a container 2 having a volume 3 and having a wall 4 surrounding the volume 3 and, arranged in the container 2, two bodies 6 consisting of a material mixture 5. The bodies 6 comprise (before the activation or storage of hydrogen) exclusively a first material 7 capable of storing hydrogen and a second material 8 as binder for the first material 7, which is present in powder form before production of the body 6 by pressing. The first material 7 is arranged in a distributed manner in a matrix of the second material 8. The material mixture 5 exhibits a high first density and a small first volume in a first state (see FIG. 3), in which a minimum amount of hydrogen is embedded in the first material 7, and exhibits a low second density and a greater second volume in a second state, in which a maximum amount of hydrogen is embedded in the first material 7. A factor of a density reduction is at least 0.13.

The second material 8 enables the body 6, starting from the first state and towards the second state, to adapt to the shape of the shape-stable container 2. Spatial constraints present in one direction 9, 10, for example by the wall 4 of the container 2, are thereby circumventable by expansion of the body 6 in a freely determinable other direction 10, 9.

The body comprises a first expansion 11 in the first direction 9 (radial direction) and a second expansion 12 in a second direction 10 (axial direction) transverse to the first direction 9. The first expansion 11 is limited in the first direction 9 by the wall 4 and the majority (for example at least 75% or even at least 90%) of a difference of first volume and second volume is realized by a variation of the second expansion 12.

The material mixture 5 of the body 6 enables the body 6, depending on a pressure acting on the body 6 from outside (due to the expansion of the body 6 upon a change of state against the shape-stable wall 4 of the container 2), to expand in the second direction 10. The body 6 may thus contact the wall 4 of the container 2 in a first state (a small distance is shown in FIG. 3—which however does not need be present) and expand towards the second state almost exclusively in the second direction 10. A contacting of the body 6 by the wall 4 of the container 2 may thus be realized in both states and in the intermediate states lying therebetween.

The container 2 may be designed such that it exhibits a stiffness or strength generating this pressure. A yielding deformation of the wall 4 (i.e. elastic or plastic deformability of the container 2) does not have to be enabled.

Each body 6 is repeatedly deformable and the arrangement and distribution of the first material 7 in the second material 8 is maintainable in the process. The second material 8 enables an expansion and contraction of the first material 7 (as a result of the take-up or release of hydrogen) without the matrix of the second material 8 dissolving. The first material 7 thus remains bound in the matrix of the second material 8 and is arranged again in the respective position after a change of state. In particular, a separation of the second material 8 and the first material 7 and in particular an agglomeration of the first material 7 does not occur.

The material mixture 5 enables the take-up of a high amount of hydrogen, wherein at the same time a permanent connection of the first material 7 and the second material 8 is realized. In this case, the second material 8 enables a deformability of the body 6 between the two (extreme) states.

Two (possibly more) bodies 6 each having the same geometry are arranged in the container 2 such that the mutually corresponding side surfaces 13 of the bodies 6 each extend parallel to one another. The bodies 6 are constructed cylindrically. The bodies 6 are arranged stacked one on top of the other and contact one another via the 5 end faces.

The end faces of the cylindrical bodies 6 are plane. The cylindrical circumferential surface of the bodies 6 extends parallel to the wall 4 of the container 2. The end faces extend perpendicularly to the circumferential surface.

The bodies 6 comprise a plurality of channels 14 extending through the body 6. Each channel 14 may be provided, for example, for the passage of a temperature control fluid. The respective body 6 may be heated and/or cooled by the temperature control fluid. The channels 14 are constructed in a straight manner. The container comprises conduits 15 which extend through the channels 14. Each body 6 contacts the conduits 15 via the respective channel 14.

The plurality of the bodies 6 are arranged in the container 2 such that the channels 14 are arranged in alignment with one another.

Modifications and variations can be made to the embodiments illustrated or described herein without departing from the scope and spirit of the invention as set forth in the appended claims. In the claims, reference characters corresponding to elements recited in the detailed description and the drawings may be recited. Such reference characters are enclosed within parentheses and are provided as an aid for reference to example embodiments described in the detailed description and the drawings. Such reference characters are provided for convenience only and have no effect on the scope of the claims. In particular, such reference characters are not intended to limit the claims to the particular example embodiments described in the detailed description and the drawings.

### REFERENCE SIGNS

1 hydrogen storage device
2 container
3 volume
4 wall
5 material mixture
6 body
7 first material
8 second material
9 first direction
10 second direction
11 first extent
12 second extent
13 side surface
14 channel
15 conduit

1. A hydrogen storage device (1), at least comprising a container (2) having a volume (3) and having a wall (4) surrounding the volume (3) and, arranged in the container (2), at least one body (6) which consists of a material mixture (5) and which comprises at least a first material (7) capable of storing hydrogen and a second material (8) as a binder for the first material (7); wherein the first material (7) is arranged in a matrix of the second material (8) in a distributed manner; wherein the material mixture (5) has a high first density and a first volume in a first state, in which a minimum amount of hydrogen is embedded in the first material (7), and has a low second density and a second volume in a second state, in which a maximum amount of hydrogen is embedded in the first material (7), wherein a factor of a density reduction with factor=1−second density/first density is at least 0.13.

2. The hydrogen storage device (1) according to claim 1, wherein the factor is between 0.13 and 0.5.

3. The hydrogen storage device (1) according to claim 1, wherein the first density is present after pressing the body (6) and is in a range of 70% to 85% of the theoretical density of the material mixture (5).

4. The hydrogen storage device (1) according to claim 1, wherein the second material (8) enables the body (6), starting from the first state and towards the second state, to adapt to a shape of the shape-stable container (2), thereby circumventing spatial constraints present in one direction (9, 10) by expansion of the body (6) in a freely determinable other direction (10, 9).

5. The hydrogen storage device (1) according to claim 1, wherein the body (6) comprises a first expansion (11) in a first direction (9) and a second expansion (12) in a second direction (10) transverse to the first direction (9); wherein the first expansion (11) in the first direction (9) is limited by the wall (4) and at least 50% of a difference of first volume and second volume is realized by a variation of the second expansion (12).

6. The hydrogen storage device (1) according to claim 1, wherein the body (6) is repeatedly deformable and the arrangement and distribution of the first material (7) in the second material (8) is maintainable in the process.

7. The hydrogen storage device (1) according to claim 1, wherein a plurality of the bodies (6) each having the same geometry are arranged in the container (2) such that the mutually corresponding side surfaces (13) of the bodies (6) each extend parallel to one another.

8. The hydrogen storage device (1) according to claim 1, wherein a plurality of the bodies (6) are arranged in a bulk in the container (2); wherein the second material (8) enables the bodies (6), starting from the first state and towards the second state, to adapt to a shape of the shape-stable container (2) and the adjacently arranged bodies (6), thereby circumventing spatial constraints present in one direction (9, 10) by expansion of the respective body (6) in a freely determinable other direction (10, 9).

9. The hydrogen storage device (1) according to claim 1, wherein the at least one body (6) comprises at least one channel (14) extending through the body (6).

10. The hydrogen storage device (1) according to claim 9, wherein a plurality of the bodies (6) are arranged in the container (2) such that the channels (14) are arranged in alignment with one another.

11. The hydrogen storage device (1) according to claim 1, wherein the second material (8) exhibits a hydrogen permeability and forms a seal of the first material (7) with respect to at least one of N₂, C, O, CO₂, CO, H₂O, H₂S and hydrocarbon compounds.
